(19) United States
(12) Patent Application Publication
(10) Pub. No.: US 2023/0298103 A1
(43) Pub. Date: Sep. 21, 2023

(54) SYSTEMS AND METHODS FOR MONITORING FOR TIMELY FILING

(71) Applicant: Change Healthcare Holdings, LLC, Nashville, TN (US)

(72) Inventor: John Kristofer Selser, Antioch, TN (US)

(21) Appl. No.: 17/695,951

(22) Filed: Mar. 16, 2022

(51) Int. Cl. G06Q 40/08; G06Q 10/06

(52) U.S. Cl. CPC G06Q 40/08; G06Q 10/063114; G06Q 10/06315

(57) ABSTRACT

Systems and methods for monitoring timely filing requirements are provided. When a claim is received by a clearinghouse from a provider, an entry is made in a table. The entry may identify the claim, the provider of the claim, a service date for the claim, the payor of the claim, and whether the claim was acknowledged. The received claim is then validated by the clearinghouse for the provider, and if validated the claim is provided to the payor. Once an acknowledgment is received for a claim, the table entry for the claim is updated to reflect the acknowledgement. For a claim in the table that show no acknowledgements were received, once the current date is within a provider-specific threshold time of the timely filing requirement for the payor, a reminder is sent to the provider that the claim is in danger of missing the timely filing requirement.

### BACKGROUND

In a medical claims clearinghouse, medical claims are received from one or more medical providers. The claims may include insurance claims for one or more payors such as insurance companies or the government. The clearinghouse may perform an initial syntax or validity check on each received claim and may send valid and correct claims to their associated payor for fulfillment.

Medical claims are subject to what are referred to as timely filing requirements. Generally, each payor requires that a medical claim be submitted within some period of time typically measured from the date that the medical service corresponding to the medical claim was provided. Each payor has their own timely filing requirement and may have different timely filing requirements based on whether a claim is an in-network or out-of-network claim.

For many reasons a claim may not be received by a payor within the time set forth in the timely filing requirement. For example, claims may be lost by the payor, or may be rejected by either the clearinghouse or the payor and the provider may forget to provide a corrected claim.

### SUMMARY

In an embodiment, systems, and methods for monitoring timely filing requirements are provided. When a claim is received by the clearinghouse from a provider, an entry is made in a table for the claim. The entry may identify the claim, the provider that provided the claim, a service date for the claim, the payor associated with the claim, and whether or not the claim was acknowledged by the payor. The received claim is then validated by the clearinghouse for the provider, and if validated the claim is provided to the payor associated with the claim. Otherwise, the claim is returned to the provider. Once an acknowledgment is received by the clearinghouse for a claim, the table entry for the claim is updated to reflect that the claim was acknowledged by the payor. For a claim in the table that shows no acknowledgements were received, once the current date is within a provider-specific threshold time of the timely filing requirement for the payor, a reminder is sent to the provider that the claim is in danger of missing the timely filing requirement.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate a system and method for monitoring the timely filing status of claims. Together with the description, the figures further serve to explain the principles of a system and method for monitoring the timely filing status of claims described herein and thereby enable a person skilled in the pertinent art to make and use the system and method for monitoring the timely filing status of claims.

FIG. 1 is an example environment for monitoring the timely filing status of submitted claims;

FIG. 2 is an illustration of an example method for monitoring the timely filing status of submitted claims;

FIG. 3 is an illustration of an example method for receiving a claim and for monitoring the timely filing status of the received claim; and

FIG. 4 shows an exemplary computing environment in which example embodiments and aspects may be implemented.

### DETAILED DESCRIPTION

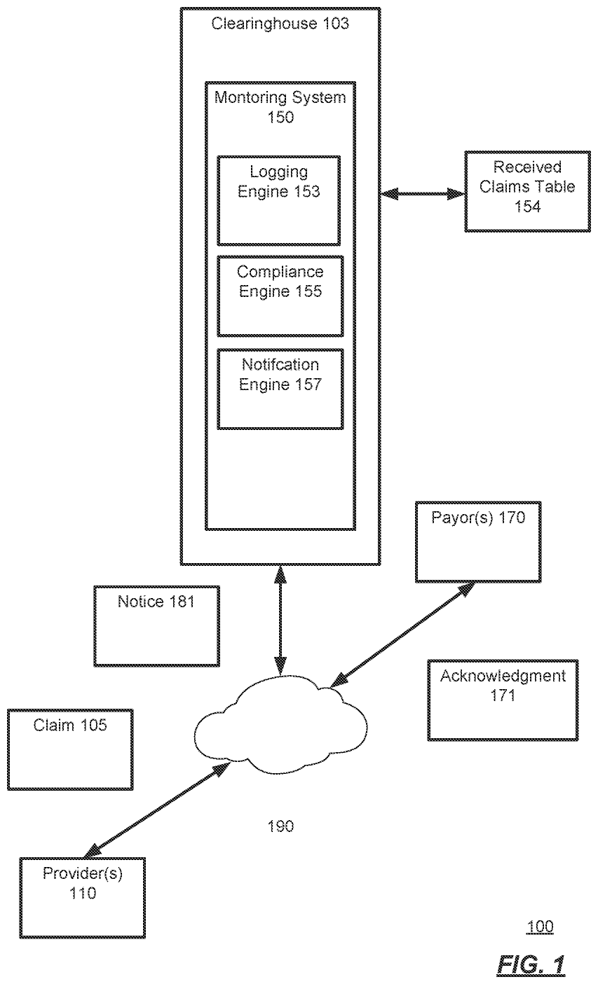

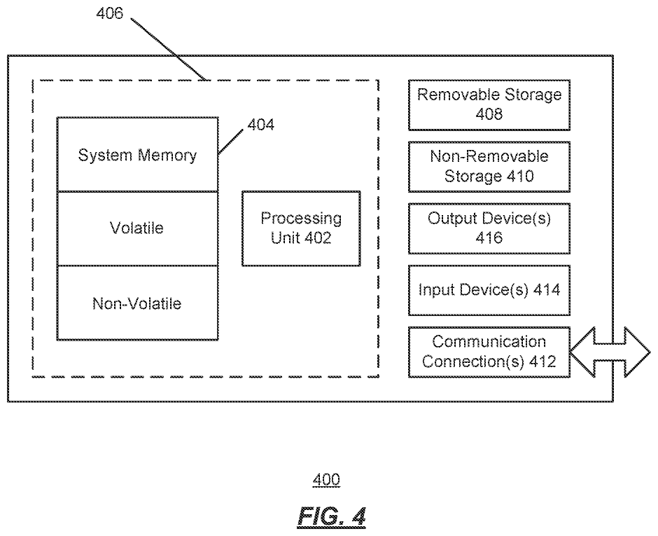

FIG. 1 is an example environment 100 for monitoring the timely filing status of submitted claims. As shown, the environment 100 includes a clearinghouse 103 that interacts with one or more providers 110 and payors 170 through a network 190. The network 190 may include a combination of public and private networks. Each of the clearinghouse 103, providers 110, and payors 170 may be implemented using one or more general purpose computing devices such as the computing device 400 illustrated with respect to FIG. 4.

The clearinghouse 103 may receive claims 105 from a variety of providers 110 through the network 190. The claims 105 may be medical claims and may be requests for reimbursement for medical services (e.g., medical exams, surgeries, tests, and imaging) and medications. The providers 110 may include any provider of medical services or medications such as doctors, hospitals, clinics, and pharmacies, for example.

Because of the complexities associated with submitting medical claims 105, rather than submitting the claims 105 directly to an associated payor 170, the providers 110 may provide the claims 105 to the clearinghouse 103. The clearinghouse 103 may validate the received claims 105, may convert the claims 105 into the format or batch preferred by the payor 170, and may provide the claims to the payor 170 through the network 190. The clearinghouse 103 may further provide the providers 110 and payors 170 an interface through which they can view their outstanding or completed claims 105. The payors 170 may include any payor of a medical claim such as an insurance company or a government entity, for example.

In general, when a payor 170 receives a claim 105 from a provider 110 via the clearinghouse 103, the payor 170 may generate and send an acknowledgement 171 to the clearinghouse 103. The acknowledgment 171 may be proof that the payor 170 received the claim 105.

As described above, providers 110 are required to submit claims 105 to a payor 170 within a period of time defined by a timely filing requirement. Generally, this period of time begins when the medical service associated with the claim 105 has been provided by the provider 110. Any claim 105 submitted after the timely filing requirement may not be paid by the payor 170.

Generally, payors 170 may have different timely filing requirements. Example timely filing requirements include 90 days, 120 days, 180 days, and 365 days.

As may be appreciated, it may be difficult for a provider 110 to keep track of whether or not their claims 105 have received by their associated payors 170 within the various timely filing requirements of the payors 170 associated with the claims 105. Failing to ensure claims 105 have been timing filed for each payor 170 can result in lost profits for providers due to payors 170 refusing to reimburse for associated medical procedures.

In order to solve the problems noted above and others, the clearinghouse 103 may further include a monitoring system 150. The monitoring system 150 tracks the claims 105 that have been submitted by providers 110 for payors 170 including the service date associated with each claim 105, and whether or not an acknowledgment 171 was received for each claim 105. For a claim 105 where no acknowledgment 171 was received, the monitoring system 150 compares the timely filing requirement for the payor 170 associated with the claims 105 with the service date associated with the claim 105. If the claim 105 is in danger of missing the timely filing requirement, the monitoring system 150 may generate and send a notice 181 or other reminder to the provider 110 associated with the claim 105 so that the provider 110 may take one or more actions to avoid missing the timely filing requirement.

The monitoring system 150 described herein provides may advantages. First, because notifications 181 of outstanding claims 105 are sent to providers 110 before the expiration of the timely filing requirement, the risk of a claim 105 being rejected for missing the timely filing requirement is greatly reduced. Second, because the monitoring system 150 handles tracking the acknowledgement status of claims 105 along with the different timely filing requirements for each payor 170, the administrative burden associated with timely filing requirements is greatly reduced for providers 110.

As shown, the monitoring system 150 may include several components including, but not limited to, a logging engine 153, a compliance engine 155, and a notification engine 157. More or fewer components may be supported. The various components of the monitoring system 150 may be implemented together or separately using one or more general purpose computing devices such as the computing device 400 illustrated with respect to FIG. 4.

The logging engine 153 may log the claims 105 received from providers 110 through the network 190 by the clearinghouse 103. In particular, when a claim 105 is received by the clearinghouse 103, the logging engine 153 may create a record for the claim 105 in what is referred to herein as the received claims table 154. Each record in the received claims table 154 may include an indicator of the received claim 105, a service date associated with the claim 105 (i.e., the date when the medical service associated with the claim 105 was provided), a provider 110 associated with the claim 105, a payor 170 associated with the claim 105, and an indicator of whether or not an acknowledgement 171 was received by the clearinghouse 103 for the claim 105 from the payor 170. The indicator may be a flag or binary value, for example.

Initially, the indicator of whether or not an acknowledgement 171 was received may be set to false or 0 by the logging engine 153 after the claim 105 is received by the clearing house 103 and sent to the payor 170. Once an acknowledgement 171 is received by the clearinghouse 103 from the payor 170 for the claim 105, the indicator of whether or not an acknowledgement 171 was received may be set to true or 1 by the logging engine 153 to indicate that the acknowledgment 171 was received.

Alternatively, or additionally, instead of using the indicator, once an acknowledgment 171 is received for a claim 105, the record of the claims 105 may be removed from the received claims table 154. Thus, the presence of a record for a claim 105 in the received claims table 154 may serve as the indication that no acknowledgment 171 was received for the claim 105.

The compliance engine 155 may determine if a claim 105 in the received claims table 154 is in danger of being non-compliant with a timely filing requirement for the payor 170 associated with the claim 105. In some embodiments, periodically (e.g., every day, hour, minute, etc.) the compliance engine 155 may determine which, if any, claims 105 represented by records in the received claims table 154 are in danger of not complying with the timely filing requirement of the associated payor 170.

As a first step, the compliance engine 155 may first identify those records in the received claims table 154 that represent claims 105 where no acknowledgment 171 is yet received. Depending on the embodiment, the compliance engine 155 may identify these claims 105 based on the field that indicates whether or not an acknowledgment 171 was received. Alternatively, the mere presence of a record in the received compliance table 154 may identify the record as representing a claim 105 where no acknowledgment 171 was received.

Once the records with no acknowledgement 171 are identified, the compliance engine 155 may identify those records whose associated claims 105 are in danger of being non-complaint with a timely filing requirement. A claim 105 may be in danger of non-compliance when the current date is within a threshold time of the timely filing requirement measured from the service date of the claim 105.

In some embodiments, the timely filing requirement for a claim 105 is based on the payor 170 associated with the claim 105. Each payor 170 may have a different timely filing requirement. The compliance engine 155 may maintain a list of payors 170 and their associated timely filing requirements 170. The list may be provided by a user or administrator or may be received by the compliance engine 155 from the payors 170.

In some embodiments, the threshold amount of time from the timely filing requirement used to determine if a claim 105 is in danger of non-compliance may be set by a user or administrator. For example, the threshold amount of time may be one week, two weeks, or three weeks. The threshold may be selected such that the provider 110 associated with a claim 105 that is in danger of non-compliance has sufficient time to resolve the issue or resubmit the claim 105.

In some embodiments, the threshold may be set or selected by the provider 110. For example, each provider 110 may use a user interface provided by the monitoring system 150 to specify the threshold time that they would like to use for their claim 105. In the event that no threshold time is provided, the compliance engine 155 may use a default threshold time. Similar to the list of timely filing requirements for the payors 170, the compliance engine 155 may maintain a list of the threshold times selected by each provider 110.

For example, a claim 105 may have a service date of Jun. 1, 2021. The threshold time for the provider 110 may be two weeks. The timely filing requirement for the payor 170 may be 180 days. In this example, the claim 105 must be filed by Nov. 28, 2021 to meet the timely filing requirement (i.e., Jun. 1, 2021+180 days). The claim 105 would be in danger of non-compliance beginning on Nov. 14, 2021 (i.e., two weeks before Nov. 28, 2021).

The notification engine 157 may generate a notice 181 for each claim 105 that was identified as being in danger of being in non-compliance of a timely filing requirement by the compliance engine 155. Depending on the embodiment, each notice 181 may indicate the claim 105, the provider 170, and the date after which the claim 105 will be non-compliant with the timely filing requirement. Each notice 181 may be an electronic notice 181 and may be transmitted by the notification engine 157 to the provider 110 that submitted the claim 105 to the clearinghouse 103.

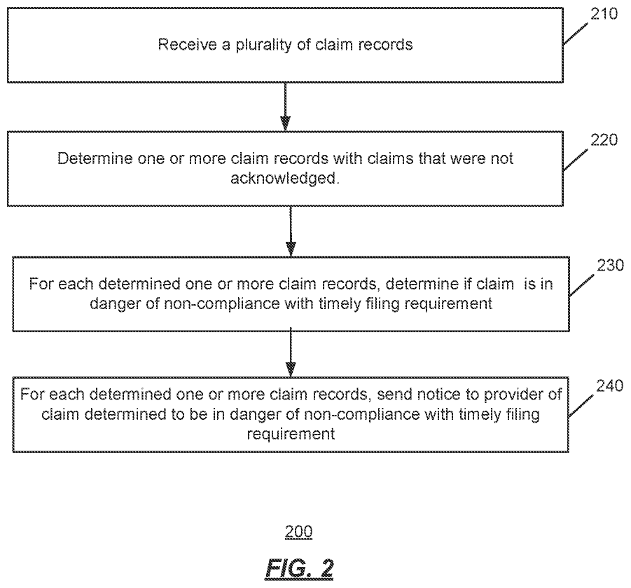

FIG. 2 is an illustration of an example method for monitoring the timely filing status of submitted claims. The method 200 may be implemented by the monitoring system 150 of the clearinghouse 103.

At 210, a plurality of claim records is received. The claims records may be received by the compliance engine 155 from the logging engine 153. The claim records may be part of the received claims table 154 and may include a claim record for every claim 105 sent to a payor 170 by the clearinghouse 103 on behalf of a provider 110. Each claim record may indicate a claim 105, a provider 110 that generated the claim, a service date associated with the claim 105, a payor 170 that is requested to pay the claim 105, and an indication of whether or not an acknowledgement 171 was received for the claim 105.

In general, each claim 105 of the claim records may have been sent or provided by the clearing house 103 to an associated payor 170. To acknowledge timely receipt of the claim 105, each payor 170 may generate and send an acknowledgement 171 back to the clearinghouse 103. Sending an acknowledgement 171 for a claim 105 indicates that the sending payor 170 has received the claim 105.

At 220, one or more claim records with claims that were not acknowledged are determined. The one or more claim records that were not acknowledged may be determined by the compliance engine 155. In some embodiments, the determinations may be made by the compliance engine 155 looking for an indication of acknowledgment 171 in each claim record of the received claims table 154.

At 230, for each of the determined one or more claim records, whether the associated claim is in danger of non-compliance with a timely filing requirement is determined. The determination may be made by the compliance engine 155. A claim may be in danger of non-compliance if a current date is within a threshold time of the timely filing requirement measured from the service date associated with the claim 105. The threshold time used for the determination may be specific to the provider 110 of the claim 105. The timely filing requirement may be specific to the payor 170 of the claim 105.

At 240, for each of the determined one or more claim records, notices are sent to the providers associated with claims that were determined to be in danger of non-compliance with the timely filing requirement. The notices 181 may be sent by the notification engine 157.

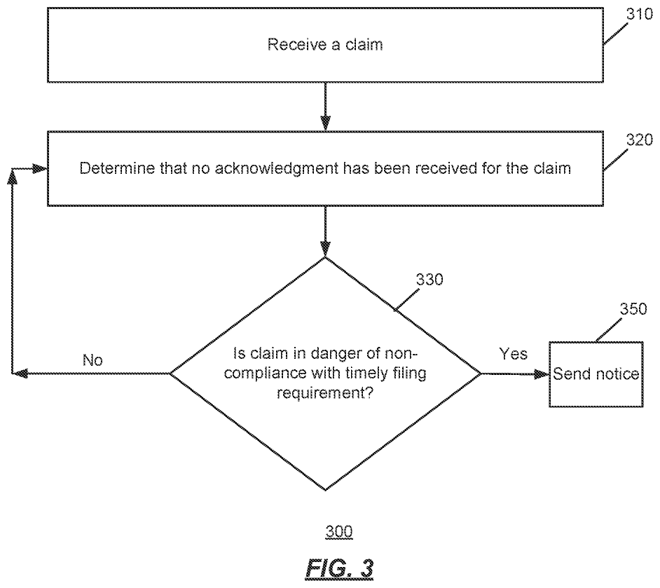

FIG. 3 is an illustration of an example method for receiving a claim and for monitoring the timely filing status of the received claim. The method 300 may be implemented by the monitoring system 150 of the clearinghouse 103.

At 310, a claim is received. The claim 105 may be received by a logging engine 153 of the monitoring system 150. The claim 105 may have been provided to a clearinghouse 103 that the monitoring system 150 is part of. The claim 105 may be a medical claim 105 and may be directed to a payor 170. The claim 105 may have been validated by the clearinghouse 103 for the provider 110 and forwarded to the payor 170. The claim 105 may have an associated service date that a medical service associated with the claim 105 was provided by the provider 110 to a patient.

At 320, that no acknowledgment has been received for the claim is determined. That no acknowledgement 171 has been received may be determined by the compliance engine 155.

At 330, whether the claim is in danger of non-compliance with the timely filing requirement is determined. The determination may be made by the compliance engine 155. In some embodiments, the claim 105 may be danger of non-compliance if a current date is within a threshold time of the timely filing requirements measured from the service date associated with the claim 105. The threshold time may be specific to the provider 110 that generated the claim 105. The timely filing requirement may be specific to the payor 170 associated with the claim 105. If the claim is in danger of non-compliance, the method 300 may continue to 340. Else, the method 300 may return to 320 and may again check if an acknowledgment 171 has been received for the claim 105.

At 350, a notice is sent. The notice 181 may be sent by the notification engine 157 to the provider 110. The notice may be an electronic message and may identify the claim 105, the payor 170, and the amount of time remaining until the timely filing requirement.

FIG. 4 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a plurality of claim records by a computing device, wherein each claim record includes a claim, a service date, a payor, a provider, and an indication of whether or not the claim was acknowledged by the provider;
determining one or more claim records of the plurality of claim records with an indication that the claim was not acknowledged by the provider by the computing device; and
for each claim record of the determined one or more claim records:
determining if a current date is within a threshold time of a timely filing requirement of the payor of the claim record based on the service date of the record by the computing device; and
if is determined that a current date is within a threshold time of a timely filing requirement of the payor of the record based on the service date of the claim record, sending a notice to the provider of the claim record by the computing device.

2. The method of claim 1, wherein the threshold time is specific to the payor of the record.

3. The method of claim 1, wherein the claim is a medical claim.

4. The method of claim 1, wherein the computing device is part of a clearinghouse.

5. The method of claim 1, further comprising:
for at least one claim record of the plurality of claim records:
receiving an acknowledgment from the provider of the claim record for the claim; and
in response to the acknowledgement, updating the claim record to indicate that the claim was acknowledged.

6. The method of claim 1, further comprising:
for each payor associated with a claim record of the plurality of claim records, receiving the timely filing requirement for the payor.

7. A method comprising:
receiving a claim by a computing device, wherein the claim is associated with a service date, a payor of a plurality of payors, and a provider of a plurality of providers;
determining that an acknowledgement of claim has not been received from the payor of the plurality of payors by the computing device;
in response to the determination, determining if a current date is within a threshold time of a timely filing requirement of the payor of the plurality of payors based on the service date; and
if is determined that the current date is within the threshold time of a timely filing requirement of the payor of the plurality of payors, sending a notice to the provider of the plurality of providers by the computing device.

8. The method of claim 7, wherein each provider of the plurality of providers is associated with a different threshold time.

9. The method of claim 7, wherein the claim is a medical claim.

10. The method of claim 7, wherein the computing device is part of a clearinghouse.

11. The method of claim 7, further comprising:
validating the received claim; and
sending the validated claim to the payor of the plurality of payors.

12. The method of claim 7, further comprising:
for each payor of the plurality of payors, receiving the timely filing requirement for the payor.

13. The method of claim 7, further comprising:
for each provider of the plurality of providers, receiving the threshold for the provider.

14. A system comprising:
at least one computing device; and
a computer-readable medium with computer-executable instructions stored thereon that when executed by the at least one computing device cause the at least one computing device to:
receive a plurality of claim records, wherein each claim record includes a claim, a service date, a payor, a provider, and an indication of whether or not the claim was acknowledged by the provider;
determine one or more claim records of the plurality of claim records with an indication that the claim was not acknowledged by the provider; and
for each claim record of the determined one or more claim records:
determining if a current date is within a threshold time of a timely filing requirement of the payor of the claim record based on the service date of the record by the computing device; and
if is determined that a current date is within a threshold time of a timely filing requirement of the payor of the record based on the service date of the claim record, sending a notice to the provider of the claim record by the computing device.

15. The system of claim 14, wherein the threshold time is specific to the payor of the record.

16. The system of claim 14, wherein the claim is a medical claim.

17. The system of claim 14, wherein the computing device is part of a clearinghouse.

18. The system of claim 14, further comprising computer-executable instructions stored thereon that when executed by the at least one computing device cause the at least one computing device to:
for at least one record of the plurality of records:
receive an acknowledgment from the provider of the record for the claim of the claim of the record; and
in response to the acknowledgement, update the record to indicate that the claim of the record was acknowledged.

19. The system of claim 14, further comprising computer-executable instructions stored thereon that when executed by the at least one computing device cause the at least one computing device to:
for each payor associated with a record of the plurality of records, receive the timely filing requirement for the payor.

20. The system of claim 14, wherein the payor is an insurance company or a government entity.
